(19) United States
(12) Patent Application Publication
(10) Pub. No.: US 2011/0112896 A1
(43) Pub. Date: May 12, 2011

(54) SYSTEM AND METHOD FOR JOINING PARTICIPANTS WITH VENDORS AND OTHER PRODUCT/SERVICE PROVIDERS

(76) Inventor: David VanZanten, Las Vegas, NV (US)

(21) Appl. No.: 12/942,645

(22) Filed: Nov. 9, 2010

Related U.S. Application Data
(60) Provisional application No. 61/259,725, filed on Nov. 10, 2009.
(60) Provisional application No. 61/333,493, filed on May 11, 2010.

(51) Int. Cl. G06Q 30/00

(52) U.S. Cl. 705/14.15

(57) ABSTRACT

A method for forming linking customers with product and or service providing entities comprising: establishing a coordinator; posting by at last one of an event host or a sponsor at least one of descriptors of an event to be staged by the event host or offerings by the sponsor; and fitting the event host with one or more sponsors.

### RELATED APPLICATIONS

The present patent application is related to and claims the benefit of U.S. Provisional Application entitled, “System For Beneficially Joining Sponsors, Event Host (Or Other Individuals Or Entities That Need Sponsors), and Participants (Or Sponsors)”, filed Nov. 10, 2009, having U.S. Ser. No. 61/259,725, in the name of the same inventor, and which is incorporated herein by reference in its entirety. This patent application further claims the benefit of U.S. Provisional Application No. 61/333,493, filed May 11, 2010, entitled “A System For Allowing Users or Potential Users of a Product or Service to Receive the Product or Service for Free or at a Reduced Rate After Purchasing Gift Cards, Vouchers, or Credit For Another Company's Product or Service” in the name of the same inventor, and which is incorporated herein by reference in its entirety.

### FIELD OF THE INVENTION

This invention relates to systems and methods for providing participants with different products and or services, and more particularly, to a system and method for joining sponsors, event host, product and or service companies and the like with different individuals.

### BACKGROUND OF THE INVENTION

Presently, most companies and or organizers of mass participant events and charities such as marathons, triathlons, concerts, wine tasting and the like use only a few different methods to attract customers and or participants. In general, depending on the particular industry, these different methods may also be the same ones used by the event host competitors. Further, these different methods may not be the best way to attract customers and or participants. Even when a product or service company or mass participant event comes up with new ways to attract customers and or participants, these new methods are generally just a modification of existing methods and as such, generally only reach the same group of participants, users, customers and the like.

Therefore, a need exists to provide a system and method to overcome the above problems. The system and method would provide companies and or organizers of mass participant events or other host product or service entities a way to attract new and existing customers and or participants.

### SUMMARY

In accordance with one embodiment, a method for linking a customer with an event host is disclosed. The method comprising: finding an event to participate in by the customer; and purchasing at least one voucher of a sponsor associated with the event by the customer, wherein proceeds from the purchase of the at least one voucher goes to the event host to run the event.

In accordance with another embodiment, a method for linking customers with product and or service providing entities is disclosed. The method comprises: establishing a coordinator; posting by at last one of an event host or a sponsor at least one of descriptors of an event to be staged by the event host or offerings by the sponsor; and fitting the event host with one or more sponsors.

In accordance with another embodiment of the present invention, a method for linking customers with product and or service providing entities is disclosed. The method comprises: establishing a coordinator; posting by a host an offering by at least one sponsor; viewing of the offering by a customer; and purchasing the offering by the customer, wherein the offering is one of a gift card, discount voucher, or the like, wherein proceeds from the purchase go to the host.

The present invention will be more apparent from the following detailed description taken in conjunction with the accompanying drawings.

### BRIEF DESCRIPTION OF THE DRAWINGS

Embodiments of the disclosure will become more fully understood from the detailed description and the accompanying drawings, wherein:

FIG. 1 is a flow chart showing one embodiment of the present invention; and

FIG. 2 is a flow chart showing another embodiment of the present invention.

### DETAILED DESCRIPTION

The present invention may allow host or other individuals or entities that need sponsorship to lower their financial risk and overhead, while at the same time increasing attendance or participation for the event/cause/endeavor (hereinafter event). The present invention will further allow event sponsors to more easily measure their return on investment and potentially calculate payback periods and breakeven points, while also insuring that many participants and or supporters purchase their products. Further, the event participants or supporters gain access to the event at no direct charge or greatly reduced charge if the participant and or supporter agrees to do business with the sponsor(s).

In accordance with another embodiment, the present invention may allow host product or service providers the ability to acquire new users for less than what it might normally cost to advertise or promote their product or services in a different manner in order to get similar results. The present invention may further allow sponsor product or service providers the ability to acquire new users for less than what it might normally cost to advertise or promote their product or service in a different manner in order to get similar results. The present invention may further allow users of the host product or service the ability to acquire that product or service at no direct charge or a greatly reduced charge, if they agree to purchase the sponsor's gift cards, coupons, and or vouchers and or otherwise do business with the sponsor.

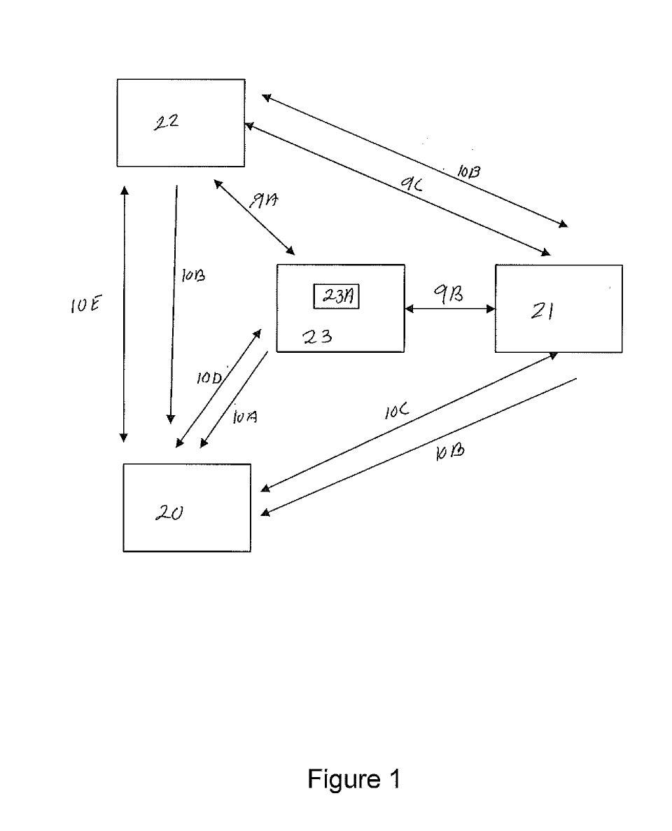

Referring to FIG. 1, a simplified block diagram depicting one embodiment of the present invention is shown. The system and method uses a coordinator 23 to aid in event host and or other entities 22 (hereinafter event host 22) to find sponsors 21 for participant events and charities such as marathons, triathlons, concerts, wining tasting, and the like (hereinafter events). This may allow the event host 22 to lower their financial risk and overhead, while at the same time increasing the number of participants 20 in the event being hosted by the event host 22. The coordinator 23 may work to orchestrate the trade of information 9A and 9B between the event host 22 and the sponsors, as well as to help in the exchange of valuable consideration, vouchers, gift cards, discount coupons, and the like 10A-10B (hereinafter vouchers 10A-10B) between the participants 20, sponsors 20, and event host 22.

In operation, an event host 22 may develop descriptors of their event, and what the host 22 would expect to receive from potential sponsors 21 if they fulfill the terms outlined in the offering and sends this information 9A to the coordinator 23. The coordinator 23 may publish this information on a website, through publications (i.e., weekly/and or monthly newsletters, etc.) and the like (hereinafter website 23A). Potential sponsors 21 may be able to search the potential offerings based on their own desire, descriptors of the event/offering, and what they would expect to offer if they fulfill the terms outlined in the offering found on the website 23A of the coordinator 23. Potential sponsors 21 may also develop their own offering and send this information 9B to the coordinator 23 who may post the sponsor offering on the website 23A. Alternatively, the potential sponsor 21 may post the sponsor offering directly on the website 23A themselves.

If the event host 22 and a sponsor(s) 21 seem to have some mutual potential fit, then the event host 22 and a sponsor(s) 21 may discuss with one another directly 9C, through the website 23A, via the coordinator 23, or by other means through lines 9A and 9B to finalize the offering which will be presented to the participants 20.

The event host 22 and or sponsors 21 may use the website 23A of the coordinator 23 to showcase 10A their offering for the participants 20. If the participant 20 finds the offering attractive, the participant 20 may use money or other valuable consideration to purchase one or more vouchers 10B from the sponsor 21 either directly 10C from the sponsor 21, through the coordinator 23 via the website 23A via line 10D, or through the event host 22 via line 10e. However, the money/other consideration may be held in escrow by the sponsor 21 or by the coordinator 23 until the event host 22 performs the duties agreed between the event host 22 and the sponsor 21, or until an alternative time mutually agreed upon by the event host 22 and the sponsor 21, after which time it is released to the event host 22. Thus, the participant 20 is funding the sponsorship, in effect, instead of the more traditional method whereby the sponsor pays the event host to fund sponsorship.

Either upon purchase by the participant 20, at the actual event, or at another mutually agreed upon time, the sponsor 21 releases the voucher 10B to the participant 20. Sometimes, the sponsor 21 may use the event host 21 or coordinator 23 to present the voucher 10B to the participant 20. Sometimes, the event coordinator 23 releases the voucher 10B via their website 23A/10A. Thus, unlike traditional sponsorship, whereby the sponsor funds the event host to gain awareness of their offering by the participants, in this system, the participant 20 in effect supplies much or all of the sponsorship consideration to the event host 22, and then can either make use of the offering from the sponsor 21 or not. If the participant 20 does not make use of the offering, it cost the sponsor 21 basically nothing. The sponsor 21 may lose out on a potential commission for the sale of the voucher 10B by the coordinator 23. If the participant does make use of the offering, the sponsor 21 has a true customer, not someone who may just have become aware of their offering via sponsorship banners, public relations etc., and the sponsor 21 achieves the sponsorship via, in effect, barter, thus saving cash. Of course, many of these aspects, i.e., banners, public relationship efforts, etc., may still be part of what the event host 22 offers the sponsor 21. Thus, the sponsor 21 has two ways to gather support, via increased awareness and more directly garnering new customers via their voucher offering. The event host 22 has a forum to find sponsorships, and may have less risk when making their offering, since participants 20 in effect receive the right to participate in the event as a bonus for purchasing the gift card, discount coupon, etc.

It should be noted that the above may be modified so that instead of the full event being funded by the vouchers 10B purchased from the sponsor 21 by participants 20 via the coordinator 23, only part of the consideration to the event host 22 is derived by the above process.

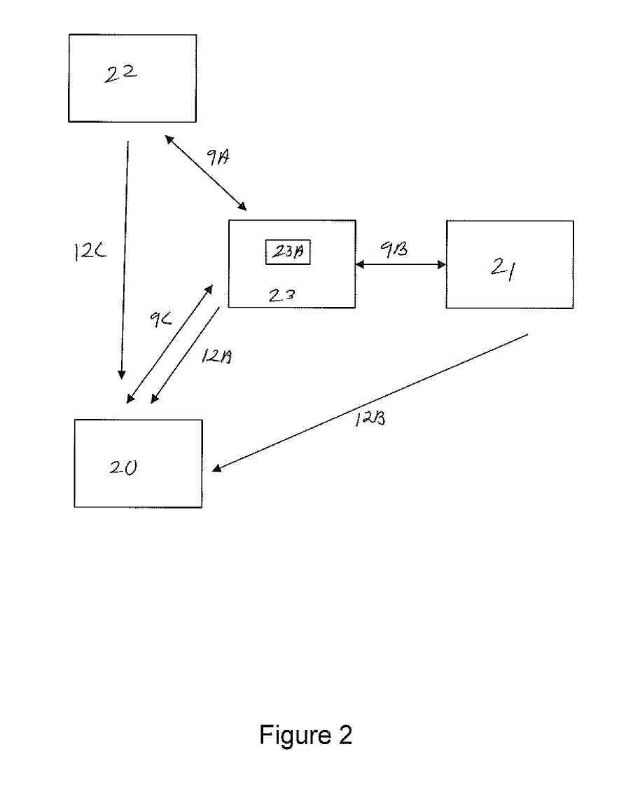

Referring to FIG. 2, another embodiment of the present invention is shown. In this system, the coordinator 23 may work to orchestrate the trade of information 9A, 9B 9C, money or other valuable consideration, and gift card(s), discount coupons, and the like 12A, 12B, 12C (hereinafter vouchers) between user/customers 20 (hereinafter customer 20), sponsors 21, and host product or service entities 22 (hereinafter host 22). Alternatively, information 9A-9C, and voucher(s) 12A-12C may be traded directly between customers 20, sponsors 21 and host 22. That is, the coordinator 23 may be hosted by the host product or service entity 22, the customer 20, or the sponsor 21 instead of being its own freestanding entity.

In operation, the host 22 works with the sponsor(s) 21 either directly or through the coordinator 23 (via 9A and or 9B) to develop an agreeable offering such that the sponsor(s) 21 feel(s) the program is beneficial to them. The offering may require the purchase of specific voucher(s) 12A-12C by the customer 20. Alternatively, the offering may feature more than one product or service offering from more than one sponsor 21, and thus may allow the customer 20 to choose which voucher(s) 12A-12C from the sponsor(s) 21 that are most desirable to the customer 20 provided the total purchase of the voucher(s) 12A-12C is at or above the amount required by the offering of the host 22.

When the offering goes “live”, the customer 20 may view the offering posted by the sponsor 21 and the host 22 at the website 23A of the coordinator 23, and choose the desired sponsor voucher(s) 12A-12C. When the customer 20 purchases the voucher(s) 12A-12C from the sponsor 21, the money or other valuable consideration flows either immediately or at an agreed to later time to the host product or service entity 22 instead of to the sponsor(s) 21. The voucher(s) 12A-12C are distributed to the customer 20. The method of distribution is either by the host product or service entity via 12C, the sponsor via 12B or the coordinator system via 12A.

In this way, the customer 20 not only receives the voucher(s) 12A-12C to be used with the sponsor 21, but the customer 20 also receives an immediate product or service, or a credit which may be used later at the host product or service entity 22 site.

The sponsors 21 are happy since they are gaining new customers 20 without having to offer cash as they might in traditional sponsorships. The sponsors 21 also have the advantage in that their major cost associated with the sponsoring is based on cost of goods sold if and when the customers 20 make use of their voucher(s) 12A-12C. And if the customer 20 does not use the voucher(s) 12A-12C, the sponsor does not incur this cost of goods sold. Also, if the customer 20 chooses to use the voucher(s) 12A-12C, the purchase by the customer 20 will likely be more than the value of their voucher. Thus, the sponsor 21 may immediately gain a profit from the customer's initial purchase.

The host 22 may gain more customers 20 for their offering since customers 20 are able to gain the host 22 product or service free, or at a greatly reduced cost, after the customer 20 has purchased the voucher(s) 12A-12C from the sponsor(s) 21.

The coordinator 23 earns its profit via a flat fee, a percentage fee based on purchases by the customer 20, or other agreement. The fee may be paid by the sponsor 21, the host 22, or the customer 20. Alternatively, if the coordinator 23 is not its own freestanding entity, it may be licensed for use via a flat fee or percentage based on revenue, number of transactions over a certain period of time, or other agreement. The fee may be paid by the sponsor 21, the host 22, or the customer 20. The coordinator system may physically reside at the host 22 site, the sponsor(s) 21 site, or the customer(s) 20 site.

The coordinator 23 may act as a conduit for communication of information and negotiation of terms between the customer 20, the sponsor 21, and the host 22 via 9C, 9B, and 9A, respectively.

In one example, the host 22 is an online TV purveyor. If the online TV purveyor 22 and an online retailer sponsor 21 develop a program offering whereby customers 20 may acquire $40 in viewing credit after purchasing $40 gift card from an online retailer 21. The online TV purveyor 22 and an online retailer 21 post this offering on the website 23A of the coordinator 23.

As another example, the host 22 is an online TV purveyor. The online TV purveyor 22 works with several different types of sponsors 21 (e.g., retailers, restaurants, service providers, etc.) to develop a program offering whereby customers 20 may acquire $40 in viewing credits after purchasing $40 in voucher(s). The customer 20 may choose which voucher(s) are of interest to them such that the total is at least $40. If they purchase more than $40 in voucher(s), additional credit may be given to the customer 20 by the online TV purveyor 22 based on the total they 20 purchased (i.e., if the customer 20 purchases one $20 voucher and one $30 voucher, the customer 20 may get $50 in credit from the online TV purveyor 22, and they get the $20 and $30 vouchers from the sponsor 21). Alternatively, the additional credit for the customer 20 may remain at the coordinator 23 to be used later by the customer 20 (i.e., if the customer 20 purchase one $20 voucher and one $30 voucher, the customer 20 may get $40 in credit from the online TV purveyor 22, and they get $10 account credit that stays with their 20 account at the coordinator system 23 which may be used with the online TV purveyor 22 or with a different host 22 later, and the customer 20 gets the $20 and $30 vouchers from the sponsor 21.) Or, the customer 20 may get $40 in credit at the online TV purveyor 22, but still get the total voucher based on the customer purchase (i.e., if the customer 20 purchases one $20 voucher and one $30 voucher, the customer 20 may only get $40 in credit from the online TV purveyor 22 with no account credit, but the customer 20 still get the $20 voucher and the $30 voucher from the sponsor 21.

Alternatively, instead of the customer 20 getting the host product or service 22 for free or for a reduced purchased price after purchasing the voucher(s) from the sponsor 21 via the coordinator system 23, the customer 20 may instead purchase the host product or service from the host product or service entity 22 via the coordination system 23 and then receive the voucher from the sponsor(s) 21 for free or for a reduced purchase price.

Alternatively, the host product or service entity 22 may instead be a charity/non-profit. Thus, the system may be used for fund raising.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process, may be implemented by one skilled in the art in view of this disclosure.

What is claimed is:

1. A method for linking customers with product and or service providing entities comprising:
establishing a coordinator;
posting by at least one of an event host or a sponsor at least one of descriptors of an event to be staged by the event host or offerings by the sponsor; and
fitting the event host with one or more sponsors.

2. The method of claim 1 further comprising establishing a communication device for listing the at least one of descriptors of an event to be staged by the event host or offerings by the sponsor.

3. The method of claim 2, wherein the communication device is a website.

4. The method of claim 1, further comprising communicating between the event host and the sponsor to finalize the offering by the sponsor which will be presented to participants of the event.

5. The method of claim 4, further comprising posting the event and offering on a website of the coordinator to showcase the event and the offering.

6. The method of claim 4, further comprising:
registering for the event by a participant; and
facilitating distribution of one of gift cards, vouchers, coupons, and the like to the participant.

7. The method of claim 4, further comprising:
registering for the event by a participant;
buying one of gift cards, coupons, vouchers and the like from the sponsor by the participant, wherein money used to purchase the one of gift cards, coupons, vouchers, and the like goes to the event host.

8. The method of claim 4, further comprising:
registering for the event by a participant;
paying an entry fee by the participant; and
giving one of gift cards, coupons, vouchers, and the like from the sponsor to the participant.

9. A method for forming linking customers with product and or service providing entities comprising:
establishing a coordinator;
establishing a communication device of the coordinator, wherein the communication device is a website;
posting by at last one of an event host or a sponsor at least one of descriptors of an event to be staged by the event host or offerings by the sponsor;
fitting the event host with one or more sponsors; and
communicating between the event host and the sponsor to finalize the offering by the sponsor which will be presented to participants of the event.

10. The method of claim 9, further comprising:
registering for the event by a participant; and
facilitating distribution of one of gift cards, coupons, vouchers, and the like to the participant.

11. The method of claim 9, further comprising:
registering for the event by the participant;
buying one of gift cards, coupons, vouchers, and the like from the sponsor by the participant, wherein money used to purchase the one of gift cards, coupons, vouchers, and the like goes to the event host.

12. The method of claim 9, further comprising:
registering for the event by a participant;
paying an entry fee by the participant; and
giving one of gift cards, coupons, vouchers and the like from the sponsor to the participant.

13. A method for forming linking customers with product and or service providing entities comprising:
establishing a coordinator;
posting by a host an offering by at least one sponsor; and
viewing of the offering by a customer; and
purchasing the offering by the customer, wherein the offering is one of a gift card, discount voucher, or the like, wherein proceeds from the purchase of the offering goes to the host.

14. The method of claim 13 further comprising establishing a communication device for listing the offering.

15. The method of claim 13, wherein the communication device is a website.

16. The method of claim 13, further comprising:
distributing the one of gift cards, discount voucher, and the like to the participant; and
distributing money paid by customer during purchasing of the offering to the host.

17. The method of claim 13, further comprising using the money for charity.

18. A method for linking a customer with an event host comprising:
finding an event to participate in by the customer;
purchasing at least one voucher of a sponsor associated with the event by the customer, wherein proceeds from the purchase of the at least one voucher goes to the event host to run the event.

19. The method of claim 18, wherein purchasing the at least one voucher allows the customer to participate in the event.

20. The method of claim 18, wherein one of all of the proceeds from the purchase of the at least one voucher goes to the event host to run the event or a predetermined percentage of the proceeds from the purchase of the at least one voucher goes to the event host to run the event.

21. The method of claim 18, wherein the event has a plurality of sponsors, the customer purchasing at least one voucher of at least one sponsor associated with the event.
